(19) United States
(12) Patent Application Publication
(10) Pub. No.: US 2012/0002955 A1
(43) Pub. Date: Jan. 5, 2012

(54) TEMPERATURE CONTROL AND POWER MANAGEMENT CONTROL SYSTEM FOR HYDRAULIC HEATING SYSTEMS

(75) Inventors: Zhongjian CHENG, FuShan city (CN); Guangyu MO, FuShan city (CN)

(73) Assignee: AMERICAN HOMETEC, INC., Wilmington, DE (US)

(21) Appl. No.: 12/828,865

(22) Filed: Jul. 1, 2010

(51) Int. Cl. F24H 1/10; H05B 1/02

(52) U.S. Cl. 392/465; 219/494

(57) ABSTRACT

A hydraulic heating apparatus is provided having a power control system and a power supply electrically coupled to the power control system. One or more heating elements are provided and electrically coupled to the power control system. A first sensor is electrically coupled to the power control system for measuring incoming water temperature to the heating system. A second sensor electrically is coupled to the power control system for measuring outgoing water temperature from the heating system. A third sensor is electrically coupled to the power control system for measuring incoming water flow to the heating system. The power consumption of the heating apparatus is managed by the data collected and analyzed from the sensors by a central processing unit and a preset temperature inputted by a user interface circuit.

### TECHNICAL FIELD

The invention relates generally to hydraulic heating systems and, more particularly, to a system and method for controlling temperature and managing power of heating systems.

### BACKGROUND OF THE INVENTION

Tankless water heaters have been developed in recent years and are known by a variety of names, including instantaneous, combination or “combi” boilers, continuous flow, inline, flash, or on-demand water heaters. This type of water heater is gaining in popularity mainly for space-saving and energy efficiency reasons. These advantages are achieved by heating water as it flows through the unit This can create cost savings by not having to maintain heated water when it is not in use as is done with tank-type water heaters.

As a practical matter, tankless water heaters may be installed throughout a household at various points-of-use (POU) or at a centralized location. They also can be used alone or in combination with a centrally located water heater. In some cases, larger tankless models may be used to provide the hot water requirements, for example, in an entire house. Whether installed at one or multiple POUs, tankless water heaters provide a continuous flow of hot water and energy savings compared with tank-type heaters, which are only able to provide a finite supply of hot water limited by tank size and hot water recovery rates.

For all of the advantages they provide, tankless water heaters on the market today may suffer from some disadvantages. First, there may be a delay between when water flow starts and when a flow detector activates one or more heating elements. This can cause colder water to flow before the desired warmer water. The flow of colder water under these circumstances is undesirable and may be particularly noticeable when a hot water faucet is repeatedly turned on and off by a user.

Because tankless water heaters only heat water upon demand, idle water in the piping is generally colder. Thus, there may be a more apparent “flow delay” for hot water to reach a distant faucet. Some tankless water heaters have minimum flow requirements before the heater is activated. This can create a gap between the temperature of cold water and the coolest warm temperature that can be achieved with a hot-and-cold water mix. This gap may also produce undesirable effects to the user.

Moreover, unlike tank-type heaters, the hot water temperature from a conventional tankless water heater is inversely proportional to the rate of water flow. In other words, the faster the flow, the less time water spends in the heating element. As a result, a certain range of desirable hot water temperatures may not be achievable or achieving a desired temperature with precision may be difficult to control.

In some convention tankless water heater systems, attempts have been made to address one or more of the aforementioned problems. Such attempts may include utilizing a number of components such as a temperature sensor to measure water outputted from the system and a designed flow switch. In other systems, an incoming water temperature sensor may also have been employed. However, there still remains a need in the art to provide a more efficient and effective tankless water heating system and method capable, for example, of not only heating water more quickly than conventional systems and methods but also with greater efficiency, precision, and safety.

The present disclosure is directed towards overcoming one or more shortcomings set forth above.

### SUMMARY OF THE INVENTION

It is, therefore, one object of the present invention to overcome the deficiencies of the prior art and to provide a system and method for managing power consumption of the heating system and controlling output water temperature accurately to a desired temperature.

In accordance with one disclosed exemplary embodiment, an apparatus is provided having a power control system and a power supply electrically coupled to the power control system. One or more heating elements are provided and electrically coupled to the power control system. A first sensor is electrically coupled to the power control system for measuring incoming water temperature to the heating system. A second sensor electrically is coupled to the power control system for measuring outgoing water temperature from the heating system. A third sensor is electrically coupled to the power control system for measuring incoming water flow to the heating system. The power consumption of the heating apparatus may be managed by the data collected and analyzed from the sensors by a central processing unit and a preset temperature inputted by a user interface circuit.

In accordance with another disclosed embodiment, a method for managing power of a hydraulic heating system may include determining a desired outgoing water temperature supplied from the heating system and measuring incoming water temperature supplied to the heating system. The method may also include measuring outgoing water temperature supplied from the heating system, measuring an incoming water flow rate supplied to the heating system, and measuring a temperature difference between the measured outgoing water temperature and the desired outgoing water temperature to determine if the power of the heating system needs to be adjusted. Additionally, a temperature difference between the measured outgoing water temperature and the desired outgoing water temperature may be measured to determine the power needed by the heating system. The disclosed method may regulate a power consumption of the hydraulic heating system based off the measured incoming water flow rate and the measured temperature difference between the incoming and the desired outgoing temperature as well as the water flow rate.

In accordance with yet another disclosed exemplary embodiment, a system for managing power of a hydraulic heating system may include a means for determining a desired outgoing water temperature supplied from the heating system and a means for measuring incoming water temperature supplied to the heating system. The system may also include a means for measuring outgoing water temperature supplied from the heating system, a means for measuring an incoming water flow rate supplied to the heating system, and a means for measuring a temperature difference between the measured incoming water temperature and the desired outgoing water temperature. Additionally, the system may further include a means for measuring a temperature difference between the measured outgoing water temperature and the desired outgoing water temperature and a means for regulating a power consumption of the hydraulic heating system based off the measured incoming water flow rate and the measured temperature difference as well as the water flow rate.

### BRIEF DESCRIPTION OF THE DRAWINGS

FIG. 1 is a schematic internal illustration of a water heating system according to an exemplary disclosed embodiment.

### DETAILED DESCRIPTION OF THE INVENTION

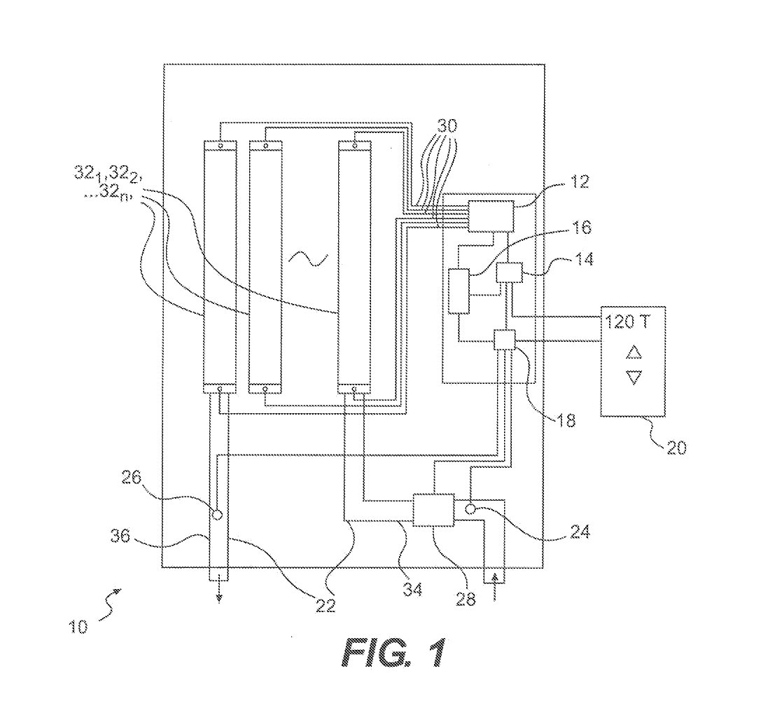

The invention will now be described with reference to the drawing figures, in which like reference numerals refer to like parts throughout. Referring to FIG. 1, an embodiment of a hydraulic heating system or water heating system 10 is provided illustrating internal components therein. For illustrative and discussion purposes, the present embodiment of the water heating system 10 is represented as a tankless water heater configuration. However, the invention is not limited to a tankless water heater configuration and may be applied to any variety of water heaters, boilers, and other hydraulic heating system.

The water heating system 10 includes a control system that manages power consumption of the water heater in order to accurately control output water temperature at a desired temperature level. Embodiments of the invention allow the water heating system 10 to more readily maintain a constant water temperature with or without changes in water flow. In addition the water heating system 10, of the described invention, also enables a desired water temperature to be achieved and maintained more quickly and accurately by use of the configuration of elements/components as described below.

A master control electric circuit 16 is provided and may be electrically connected to various components within the water heating system 10 such as via internally connected electric wires 30. Master control electric circuit 16 or power management circuit may include a logical circuitry configuration containing one or more combination of electrical components including, for example, TRIACs (silicon-controlled rectifier), relay(s), or a combination thereof. The amount and specification of electronic components is appropriately selected, at least, based upon the size of heating elements and/or heating requirements of the water heating system 10.

The power control system of water heating system 10 preferably includes an AC power supply 12 and a direct-current and AC power supply exchange circuit 14. Both the AC power supply 12 and a direct-current and AC power supply exchange circuit 14 are electrically connected to the master control electric circuit 16. One or more heating elements (321, 322 . . . 32n) may be provided for heating water supplied to each one of the heating elements. The one or more heating elements (321, 322 . . . 32n) may be arranged relative to the flow direction of water. Multiple heating elements may be arranged in serial, parallel, or a combination of serial and parallel connection-type configurations. Each heating element is electrically connected to and controlled by a master control electric circuit 16. Thus, the amount of power supplied to one or more heating elements (321, 322 . . . 32n) is supplied by the AC power supply 12 and regulated by the master control electric circuit 16. The power requirements of the water heating system 10 may increase gradually up to and including reaching the maximum power depending on the system requirements as discussed below.

In one preferred embodiment, central processing unit (CPU) 18 is provided and electrically connected to master control electric circuit 16. A user operation interface circuit 20 is also provided and electrically coupled to the master control electric circuit 16 and CPU 18. The user operation interface circuit 20 allows a user to manually set and/or adjust a prescribed temperature of the water heating system 10 at a desired level.

The water heating system 10 may be configured to receive and output water via pipes 22 coupled thereto. Thus, in one embodiment, an inlet water pipe 34 is provided to supply water to the water heating system 10. Water pipe 34 may be constructed of metal or non-metal material. Water flow sensor 28 is provided to measure water flow into the water heating system 10. An incoming water temperature sensor 24 may be utilized to measure the incoming water temperature of the water heating system 10. Each of the water flow sensor 28 and the incoming water temperature sensor 24 may be electrically connected to the CPU 18.

Outlet water pipe 36 may be provided to transfer water from the water heating system 10 to one or multiple POUs. Water pipe 36 may be constructed of metal or non-metal material. The disclosed embodiment provides an output water temperature sensor 26 to measure the temperature of the output water. The output water temperature sensor 26 may also be electrically coupled to the CPU 18.

Thus, unlike some convention tankless water heater systems which may merely provide a limited number of components (such as an output water temperature sensor and flow switch, or a combination of an output water temperature sensor, flow switch, and incoming water temperature sensor), the presently described invention also employs the water flow sensor 28 to facilitate achieving and maintaining a constant water temperature for a user. By monitoring the water flow into water heating system 10, the described invention will more readily maintain a constant water temperature with or without changes in water flow. In addition water heating system 10 also enables a desired water temperature to be achieved and maintained more quickly and accurately by use of the water flow sensor 28 in combination with the additional components described herein.

The CPU 18 regulates the master control electric circuit 16 by analyzing and calculating the data collected through various components of the water heating system 10. This allows the CPU 18 to manage power consumption via the master control electric circuit 16 by analyzing the combined data collected from the incoming water temperature sensor 24, the output water temperature sensor 26, the water flow sensor 28, and the desired temperature set by the user via the user operation interface circuit 20. Upon doing so, the CPU 18 controls and adjusts the AC power supply 12 to supply increased or decreased power, as needed.

In operation, a user sets the desired water temperature for the heating system 10 via user operation interface circuit 20. The user operation interface circuit 20 may include any electronic and/or mechanical components appropriately configured to allow a user to enter electrical information into the water heating system 10. The user operation interface circuit 20 may also include a display device for interacting with the user during operation. The water heating system 10 is electrically configured to monitor the incoming water temperature (via sensor 24), the output water temperature (via sensor 26), the incoming water flow (via sensor 28), and the desired temperature set by the user (via user operation interface circuit 20).

The water heating system 10 is configured to provide an amount of power (e.g., via the CPU 18) to the water heating system 10 based upon an amount of water flowing through the system and a desired temperature of the output water set by a user. The power requirement is used to heat the water flowing through the water heating system 10 to achieve and maintain the desired water temperature set by the user. If the water flow varies into the water heating system 10, the system automatically adjusts the power (e.g., via the CPU 18) as necessary to maintain the desired output water temperature.

The amount of power required by water heating system 10 to achieve a desired output water temperature is determined, inter alia, by measuring the difference in temperature between the incoming water temperature and the temperature set by the user. The water heating system 10 will also measure an output temperature of the output water. If the output temperature is more or less than a preset value range from the temperature set by the user, the water heating system 10 will adjust its power output required to achieve the temperature set by the user based on the water flow (i.e., the amount of water to be heated) and the temperature difference between the incoming water temperature and the temperature set by the user. In one embodiment, the aforementioned value range may be set, for example, at 2 degrees F.+/− from the temperature set by the user.

A checking function of the water heating system 10 may be employed to ensure the heating system is accurately achieving and maintaining the temperature set by the user within a prescribed amount of time. For example, in one embodiment, the checking function of water heating system 10 may be configured to occur multiple times per second. In another embodiment, the checking function of water heating system 10 may be configured to occur multiple times over a period of multiple seconds. Thus, given the above exemplary preset value range of 2 degrees F.+/− from the temperature set by the user, the water heating system 10 is configured to check multiple times over a prescribed period of time whether the water output temperature is within +/−2 degrees F. from the temperature set by the user.

Thus, the disclosed invention provides a simplified electronic circuit structure while accurately managing the power needed to control output water temperature. It will be apparent to those skilled in the art that various modifications and variations can be made in the disclosed apparatus and method without departing from the scope of the disclosure. For example, while embodiments are described applicable to tankless water heaters, the system, described herein, may be employed in not only high efficiency electric water heaters, but also to additional systems including, for example, boilers and other residential, commercial, or industrial hydraulic heating systems.

Additionally, other embodiments of the apparatus and method will be apparent to those skilled in the art from consideration of the specification. It is intended that the specification and examples be considered as exemplary only, with a true scope of the disclosure being indicated by the following claims and their equivalents.

What is claimed is:

1. A hydraulic heating apparatus comprising:
a power control system;
a power supply electrically coupled to the power control system;
one or more heating elements electrically coupled to the power control system;
a first sensor electrically coupled to the power control system for measuring incoming water temperature to the heating system;
a second sensor electrically coupled to the power control system for measuring outgoing water temperature from the heating system; and
a third sensor electrically coupled to the power control system for measuring incoming water flow to the heating system.

2. The apparatus of claim 1, wherein the power control system comprises:
a central processing unit; and
a power supply electrically coupled to the central processing unit;

3. The apparatus of claim 2, wherein the power supply is electrically coupled to the central processing unit via a master control electric circuit.

4. The apparatus of claim 3, wherein the master control electric circuit comprises one or more TRIACs (silicon-controlled rectifier), relay, or combination thereof, operatively connected to work in combination with the first sensor, the second sensor, and the third sensor.

5. The apparatus of claim 2, wherein the power supply comprises an AC power supply.

6. The apparatus of claim 2, further comprising:
a direct-current and AC power supply exchange circuit.

7. The apparatus of claim 1, further comprising:
an inlet water pipe connected to the heating system; and
an outlet water pipe connected to the heating system.

8. The apparatus of claim 7, wherein the inlet water pipe and the outlet water pipe are of metal or non-metal material.

9. The apparatus of claim 1, wherein the heating system is a tankless water heater.

10. The apparatus of claim 1, wherein the heating system is a boiler.

11. A method for managing power of a hydraulic heating system comprising:
determining a desired outgoing water temperature supplied from the heating system;
measuring incoming water temperature supplied to the heating system;
measuring outgoing water temperature supplied from the heating system;
measuring an incoming water flow rate supplied to the heating system;
measuring a temperature difference between the measured outgoing water temperature and the desired outgoing water temperature to determine if the power of the heating system needs to be adjusted;
measuring a temperature difference between the measured outgoing water temperature and the desired outgoing water temperature to determine the power needed by the heating system; and
regulating a power consumption of the hydraulic heating system based off the measured incoming water flow rate and the measured temperature difference between the incoming and the desired outgoing temperature.

12. The method of claim 11, wherein regulating the power consumption comprises:
receiving and analyzing the measured incoming water temperature;
receiving and analyzing the measured outgoing water temperature;
receiving and analyzing the measured incoming water flow rate;
receiving and analyzing the desired outgoing water temperature;
receiving and analyzing the measured temperature difference between the outgoing water temperature and the desired outgoing water temperature;
receiving and analyzing the measured temperature difference between the incoming water temperature and the desired outgoing water temperature; and
adjusting a power supplied to the heating system based on the analysis of the measured incoming water temperature, the measured outgoing water temperature, the desired outgoing water temperature, the measured incoming water flow rate, and the measured temperature difference.

13. The method of claim 12, wherein the receiving and analyzing steps are performed multiple times per second or per multiple seconds.

14. The method of claim 12, further comprising:
providing a central processing unit to perform the receiving and analyzing steps and adjust the power supplied to the heating system based upon the analysis of the measured incoming water temperature, the measured outgoing water temperature, the desired outgoing water temperature, the measured incoming water flow rate, and the measured temperature difference.

15. A system for managing power of a hydraulic heating system comprising:
means for determining a desired outgoing water temperature supplied from the heating system;
means for measuring incoming water temperature supplied to the heating system;
means for measuring outgoing water temperature supplied from the heating system;
means for measuring an incoming water flow rate supplied to the heating system;
means for measuring a temperature difference between the measured incoming water temperature and the desired outgoing water temperature;
means for measuring a temperature difference between the measured outgoing water temperature and the desired outgoing water temperature; and
means for regulating a power consumption of the hydraulic heating system based off the measured incoming water flow rate and the measured temperature difference.

16. The method of claim 15, wherein the means for measuring incoming water temperature supplied to the heating system, the means for measuring outgoing water temperature supplied from the heating system, and the means for measuring an incoming water flow rate supplied to the heating system comprises sensors.

17. The method of claim 15, wherein the means for determining a desired outgoing water temperature supplied from the heating system comprises a user operation interface circuit.

18. The method of claim 15, wherein the means for measuring a temperature difference between the measured outgoing water temperature and the desired outgoing water temperature comprises a central processor unit coupled to the means for measuring outgoing water temperature and the means for determining the desired outgoing water temperature.

19. The method of claim 15, wherein the means for measuring a temperature difference between the measured incoming water temperature and the desired outgoing water temperature comprises a central processor unit coupled to the means for measuring incoming water temperature and the means for determining the desired outgoing water temperature.

20. The method of claim 15, wherein the means for regulating a power consumption of the hydraulic heating system based off the measured incoming water flow rate and the measured temperature difference comprises a central processing unit coupled to a power supply.
